(19) United States
(12) Patent Application Publication
(10) Pub. No.: US 2023/0309024 A1
(43) Pub. Date: Sep. 28, 2023

(54) UE SIGNALING INSERTION LOSS FOR SRS ANTENNA SWITCHING

(71) Applicant: QUALCOMM Incorporated, San Diego, CA (US)

(72) Inventors: Ryan Scott Castro SPRING, San Diego, CA (US); Muhammad Sayed Khairy ABDELGHAFFAR, San Jose, CA (US); Alexandros MANOLAKOS, Escondido, CA (US); Krishna Kiran MUKKAVILLI, San Diego, CA (US); Timo Ville VINTOLA, San Diego, CA (US)

(21) Appl. No.: 18/020,075

(22) PCT Filed: Oct. 5, 2021
(86) PCT No.: PCT/US2021/053667

§ 371 Date: Feb. 6, 2023

(30) Foreign Application Priority Data
Oct. 9, 2020 (GR) 20200100609

(51) Int. Cl. H04W 52/24; H04W 52/36

(52) U.S. Cl. CPC H04W 52/242; H04W 52/367

(57) ABSTRACT

Method and apparatus to signal insertion loss for SRS antenna switching. The apparatus determines an insertion loss for each antenna of a plurality of antennas. The apparatus generates an offset matrix correction based at least on the insertion loss for each antenna of the plurality of antennas. The apparatus transmits the offset matrix correction to a base station. The apparatus may transmit an SRS, at a maximum power, from each antenna of the plurality of antennas to each receive antenna of the base station. The apparatus may collect insertion loss information for each antenna of the plurality of antennas. The insertion loss information indicates at least a power difference for each of the plurality of antennas at the UE.

### CROSS REFERENCE TO RELATED APPLICATION(S)

This application claims the benefit of and priority to Greek Patent Application Serial No. 20200100609, entitled “UE Signaling Insertion Loss for SRS Antenna Switching” and filed on Oct. 9, 2020, which is expressly incorporated by reference herein in its entirety.

### TECHNICAL FIELD

The present disclosure relates generally to communication systems, and more particularly, to a configuration for a UE to signal insertion loss for sounding reference signal (SRS) antenna switching.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a device at a UE. The device may be a processor and/or a modem at a UE or the UE itself. The apparatus determines an insertion loss for each antenna of a plurality of antennas. The apparatus generates an offset matrix correction based at least on the insertion loss for each antenna of the plurality of antennas. The apparatus transmits the offset matrix correction to a base station.

In an aspect of the disclosure, a method, a computer-readable medium, and an apparatus are provided. The apparatus may be a device at a base station. The device may be a processor and/or a modem at a base station or the base station itself. The apparatus receives, from a user equipment (UE), an offset matrix correction comprising an insertion loss for each antenna of a plurality of antennas of the UE. The apparatus generates a real channel matrix based on a measured channel matrix and the offset matrix correction. The apparatus determines a multiple input multiple output (MIMO) link for communication with the UE, based at least one the generated real channel matrix.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 illustrates an example of an SRS antenna switching procedure.

FIG. 5 illustrates an example of an SRS antenna switching procedure.

FIG. 6 is a call flow diagram of signaling between a UE and a base station.

FIG. 7 is a flowchart of a method of wireless communication.

FIG. 8 is a flowchart of a method of wireless communication.

FIG. 9 is a diagram illustrating an example of a hardware implementation for an example apparatus.

FIG. 10 is a flowchart of a method of wireless communication.

FIG. 11 is a flowchart of a method of wireless communication.

FIG. 12 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, aggregated or disaggregated components, end-user devices, etc. of varying sizes, shapes, and constitution.

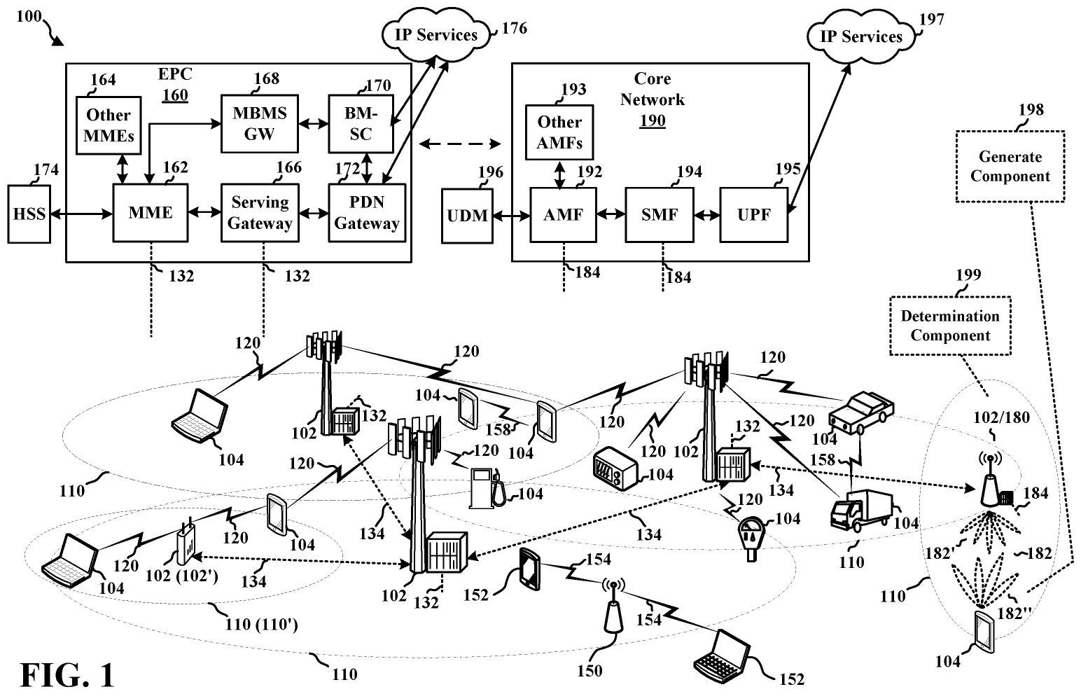

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may be configured to generate a static offset related to an imbalance on transmission power for each antenna. For example, the UE 104 may comprise a generate component 198 configured to generate an offset matrix based at least one the insertion loss for each antenna of the plurality of antennas. The UE 104 may determine an insertion loss for each antenna of a plurality of antennas. The UE 104 may generate an offset matrix correction based at least on the insertion loss for each antenna of the plurality of antennas. The UE 104 may transmit the offset matrix correction to the base station 180.

Referring again to FIG. 1, in certain aspects, the base station 180 may be configured to determine a channel estimate of MIMO links based on insertion loss at the UE. For example, the base station 180 may comprise a determination component 199 configured to determine a MIMO link for communication with the UE 104, based at least on a generated real channel matrix. The base station 180 may receive, from the UE 104, an offset matrix correction comprising an insertion loss for each antenna of a plurality of antennas of the UE 104. The base station 180 may generate a real channel matrix based on a measured channel matrix and the offset matrix correction. The base station 180 may determine a MIMO link for communication with the UE 104, based at least one the generated real channel matrix.

Although the following description may be focused on 5G NR, the concepts described herein may be applicable to other similar areas, such as LTE, LTE-A, CDMA, GSM, and other wireless technologies.

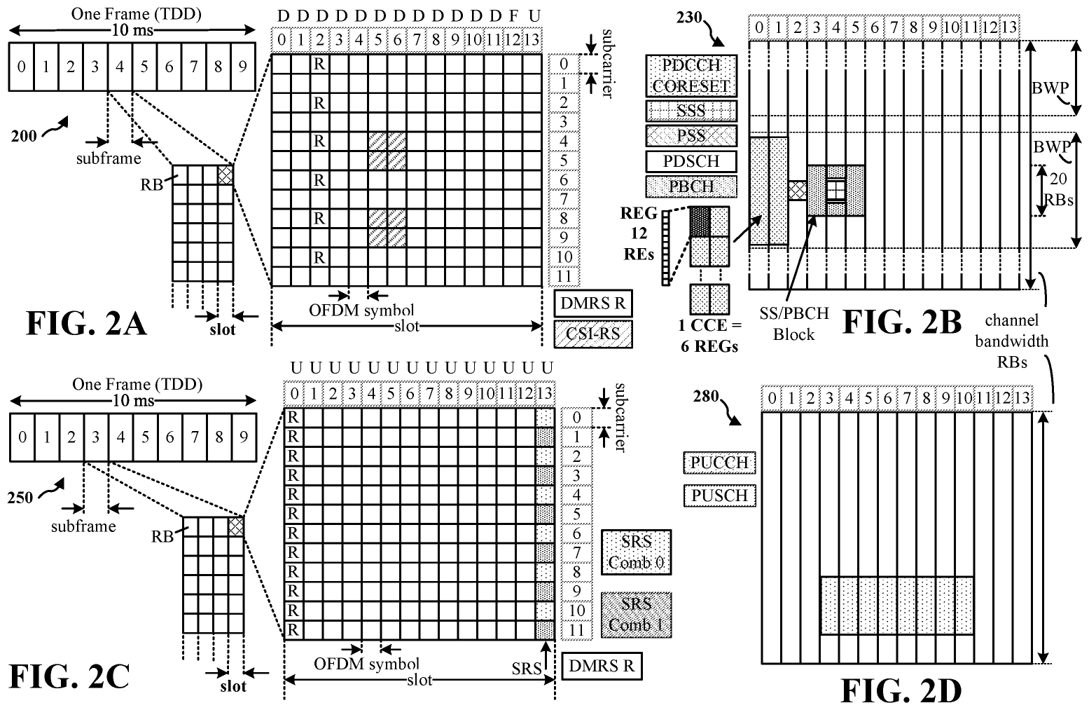

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | Cyclic |
|---|---|---|
| μ | Δf = 2^{μ} · 15[kHz] | prefix |
| 0 | 15 | Normal |
| 1 | 30 | Normal |
| 2 | 60 | Normal, |
| | | Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

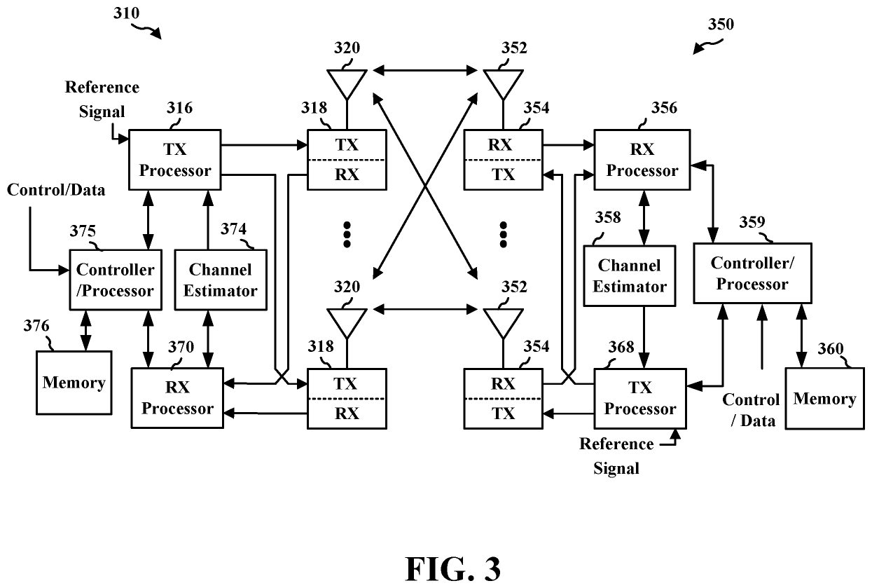

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate a radio frequency (RF) carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

At least one of the TX processor 316, the RX processor 370, and the controller/processor 375 may be configured to perform aspects in connection with 198 of FIG. 1.

In wireless communication systems, a UE, in a TDD SRS antenna switching process, may send a transmission to all the receive antennas at a receiver, such as a base station. In some instances, not all of the post power amplifier (PA) to antenna insertion losses may be equal. Some insertion losses may be worse than the primary transmitter of the UE. The may result in a power imbalance between antennas that are being sounded. The delta power (e.g., different) between antennas maybe ≤3 dB for frequencies<n79, while the delta power between antennas maybe ≤4.5 dB for frequencies=n79. If the imbalance of power is greater than allowable delta between antennas, the imbalance may impact the downlink throughput.

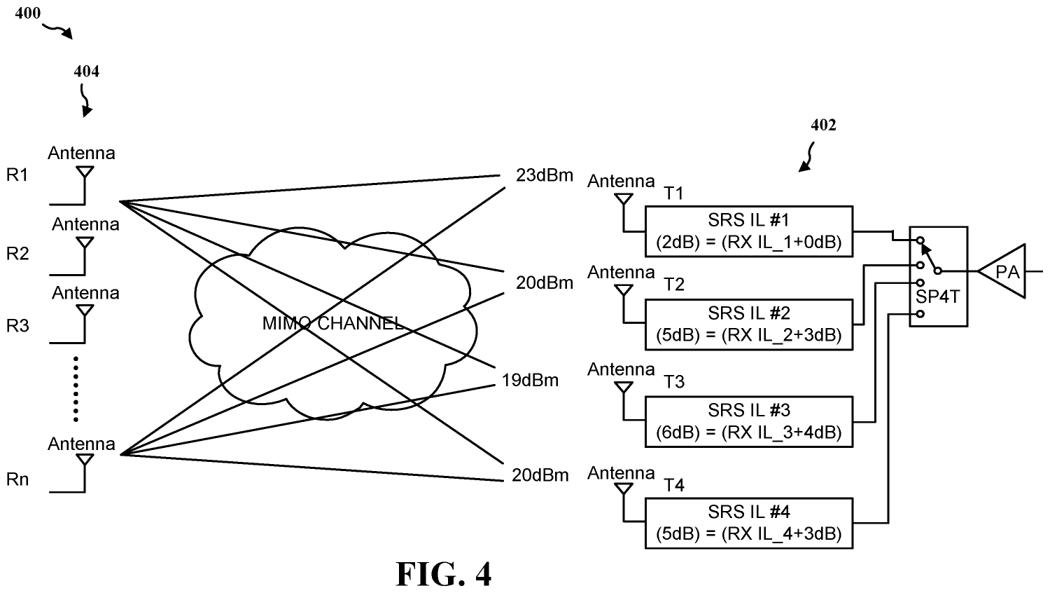

FIG. 4 illustrates an example 400 of an SRS antenna switching procedure between a UE 402 and a base station 404. The UE 402 may transmit at a maximum power at each antenna to each receive antenna of the base station 404. The base station 404 may utilize the reception of the transmission from the UE 402, at maximum power, in order to determine a channel estimate (e.g., phase and magnitude) per antenna at the UE 402. The PA of the UE 402 has fixed maximum output power and insertion loss (e.g., front end loss) may be present between the PA and the antenna. The insertion loss may differ per transmission path. For example, with reference to the example 400 of FIG. 4, a first antenna T1 may have a 2 dB insertion loss, such that the maximum transmission power is 23 dBm, while a second antenna T2 may have a 5 dB insertion loss, such that its maximum transmission power is 20 dBm. In such an instance, the UE may only be able to transmit at a maximum transmission power on the first antenna T1. The base station 404 is unaware of such insertion loss imbalance between antennas and may affect the ability of the base station 404 to determine an accurate channel estimate.

Aspects presented herein provide a configuration for a UE to signal insertion loss imbalance between its antennas to a base station. For example, the UE may be configured to generate a static offset related to the imbalance on transmission power for each antenna. The base station may utilize the static offset to optimize the determination of the channel estimate based on insertion loss at the UE.

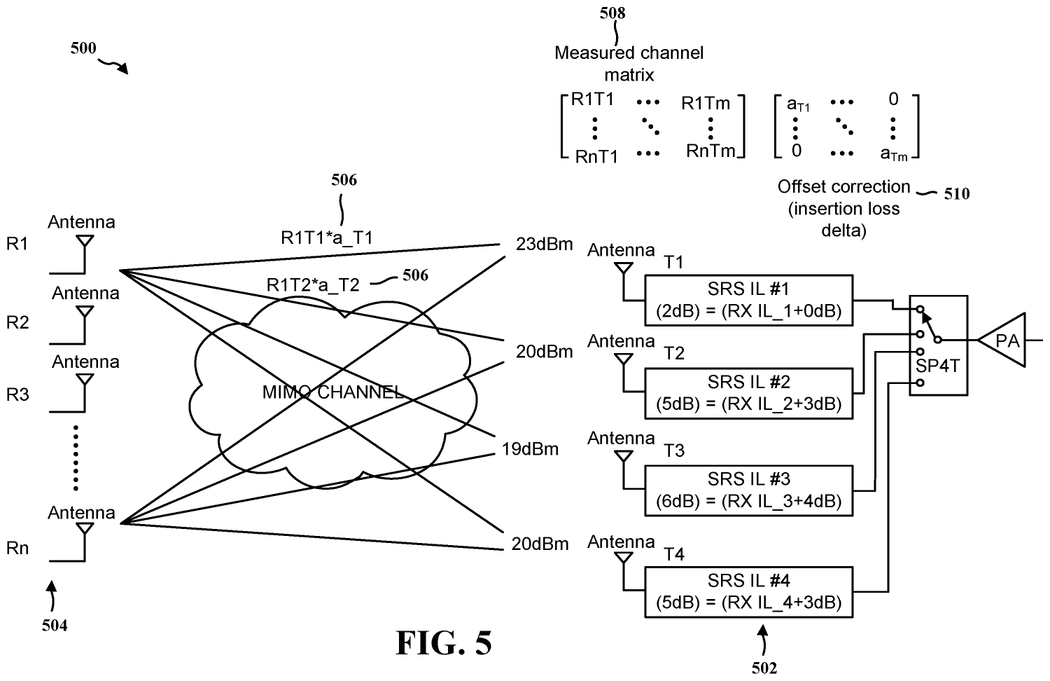

FIG. 5 illustrates an example 500 of an SRS antenna switching procedure between a UE 502 and a base station 504. SRS may be utilized to sound the MIMO channel (e.g., phase and magnitude), and as such, the UE 502 may be configured to provide a static offset to the base station 504 indicating the imbalance of transmission power between SRS antenna transmissions. The static offset may be added to the channel matrix 508 seen by the base station 504. The amplitude imbalance may have a significant impact compared to the phase. For example, the once the base station 504 receives the static offset, the base station 504 may apply the static offset to the measured transmission from the UE 502. For example, each respective transmission (e.g., 506, 506) from the UE 502 may include the offset in order to compensate for the insertion loss at each respective antenna. As shown in FIG. 5, a transmission 506 from a first antenna T1 from the UE 502 to a first receive antenna R1 of the base station 504 may comprise R1T1*a_T1, where R1T1 is the measured channel and a_T1 is an offset coefficient accounting for the insertion loss at the first antenna T1 of UE 502. At least one advantage of the disclosure is that by utilizing the static offset, the base station 504 may improve the channel estimate of the MIMO channel, which may improve downlink throughput. At least another advantage is that the static offset may alleviate hardware challenges, such as but not limited to, requiring a higher output power. In some instances, the offset coefficients (e.g., 510) may be signaled to the base station at the beginning of a transmission (e.g., call) between the UE 502 and the base station 504. The combination of the measured channel matrix 508 and the offset correction 510 may allow the base station 504 to generate a real channel matrix which may improve the channel estimate. In some aspects, the offset may be configured to account for the individual receive insertion loss delta.

In some aspects, the reporting of the insertion loss may be a per-band or a per-band in a band combination UE capability. The insertion loss may apply to SRS antenna switching usage and also for carrier switching. The base station may be configured to derive the downlink channel state information (CSI) acquisition and correct for the insertion loss at the transmission chains which may not be present at the receive chains. In some aspects, the reporting may be explicit of the actual insertion loss per antenna port (e.g., 2 dB, 5 dB, 6 dB, 5 dB), while in some aspects, the reporting may be differential with respect to antenna port 0 (e.g., 3 dB, 4 dB, 3 dB). In both aspects, the resolution of reporting may comprise a resolution of 0.5 dB.

In some aspects, the insertion loss reporting may depend on the antenna switching configuration. For example, a configuration of 1T4R (e.g., 1 transmit, 4 receive) may have different insertion losses in comparison to 2T4R, and/or different from 1T2R or 2T2R. In some aspects, a reporting of insertion loss relative to a primary antenna may be different for different antenna switching configurations. For example, UEs that report combined SRS switching capability (e.g., 1T4R-2T4R), multiple sets of insertion loss may be reported for different SRS switching configurations.

In some aspects, the UE may have more than 4 antennas, but the sounding may be limited to 4 antennas (e.g., 1T4R with 8 antennas). In some aspects, a UE with 4 antennas may be configured to adapt the number of receive antennas, such as turning off some of the antennas, for power saving needs and channel adaption.

In some aspects, the UE may indicate the insertion loss of the active sounded antenna ports, in order to provide an ordering of the insertion loss and active sounded antenna. This may reduce or limit ambiguity on which insertion loss value corresponds to which antenna. In such instances, the UE may generate a MAC-CE message that comprises an index to a sequence of insertion losses or an association of an insertion loss to an SRS resource of an SRS resource set, such that dynamic updating or reordering would be possible.

In some aspects, the insertion loss may appear when the UE transmits SRS at high or maximum transmit power levels. UEs transmitting below a certain threshold may allow the UE to transmit the same power across all antennas, such that the insertion loss may not be problematic. In order for the UE to indicate that insertion loss is present, the UE may transmit a static report or a dynamic report. In the static report, the UE may report the transmission power threshold above which insertion loss should be considered, which may be part of UE capability. If the transmission power threshold is not transmitted, then the base station may assume that the reported insertion loss values are valid of all transmission power levels, which may provide the advantage to simplify the power control. In the dynamic report, the UE may indicate to the base station using MAC-CE. The transmission power threshold may be based on the antenna switching configuration, the operating band, and/or the RB allocation, waveform (e.g., CP-OFDM vs. DFT-s-OFDM), and modulation scheme.

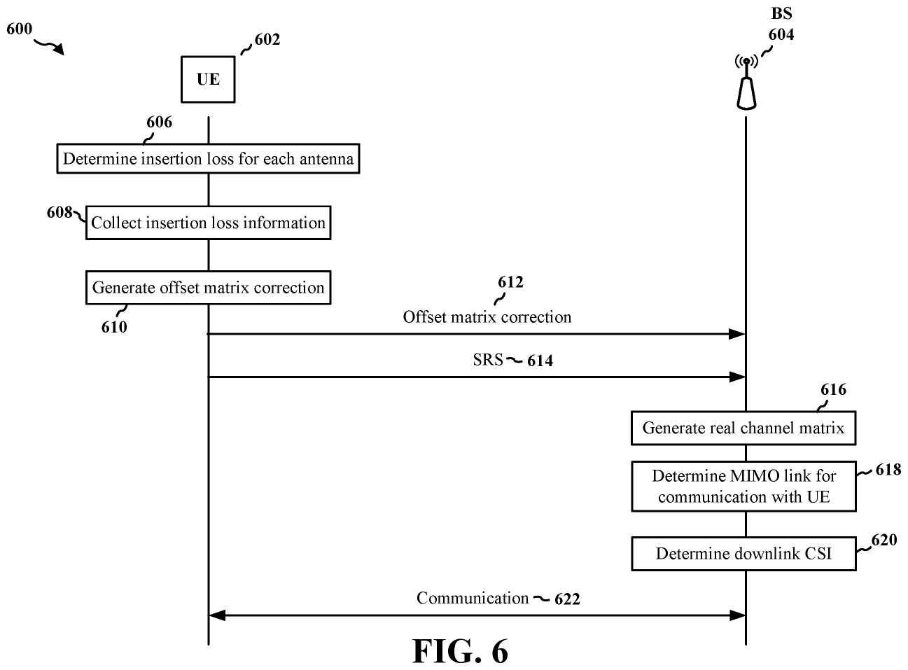

FIG. 6 is a call flow diagram 600 of signaling between a UE 602 and a base station 604. The base station 604 may be configured to provide at least one cell. The UE 602 may be configured to communicate with the base station 604. For example, in the context of FIG. 1, the base station 604 may correspond to base station 102/180 and, accordingly, the cell may include a geographic coverage area 110 in which communication coverage is provided and/or small cell 102′ having a coverage area 110′. Further, a UE 602 may correspond to at least UE 104. In another example, in the context of FIG. 3, the base station 604 may correspond to base station 310 and the UE 602 may correspond to UE 350.

As illustrated at 606, the UE 602 may determine an insertion loss. The UE 602 may determine the insertion loss for each antenna of a plurality of antennas. In some aspects, the insertion loss for each antenna of the plurality of antennas may be based at least on an antenna switching configuration.

As illustrated at 608, the UE 602 may collect insertion loss information. The UE 602 may collect the insertion loss information for each antenna of the plurality of antennas. The insertion loss information may indicate at least a power difference for each of the plurality of antennas at the UE 602.

As illustrated at 610, the UE 602 may generate an offset matrix correction. The UE 602 may generate the offset matrix correction based at least on the insertion loss for each antenna of the plurality of antennas of the UE 602. In some aspects, the offset matrix correction may comprise a report of an insertion loss delta for each antenna of the plurality of antennas with respect to a first antenna of the plurality of antennas. The offset matrix correction may comprise offset coefficients corresponding to the insertion loss delta for each antenna of the plurality of antennas. In some aspects, the offset matrix correction may comprise a report of the insertion loss for each antenna of the plurality of antennas. In some aspects, the offset matrix correction may comprise an index for a sequence of active antennas of the plurality of antennas. The sequence of active antennas may be associated with a respective insertion loss. The offset matrix correction is transmitted via medium access control control element (MAC-CE). In some aspects, the offset matrix correction may be based on a per band or a per band in a band combination.

As illustrated at 612, the UE 602 may transmit the offset matrix correction. The UE 602 may transmit the offset matrix correction to the base station 604. The base station 604 may receive the offset matrix correction from the UE 602.

As illustrated at 614, the UE 602 may transmit a sounding reference signal (SRS) to each receive antenna of the base station 604. The UE 602 may transmit the SRS from each antenna of the plurality of antennas to each receive antenna of the base station 604. The UE 602 may transmit the SRS, at a maximum power, from each antenna of the plurality of antennas to each receive antenna of the base station 604. The base station 604 may receive the SRS from the UE 602.

As illustrated at 616, the base station 604 may generate a real channel matrix. The base station 604 may generate the real channel matrix based on a measured channel matrix and the offset matrix correction.

As illustrated at 618, the base station 604 may determine a MIMO link for communication with the UE 602. The base station 604 may determine the MIMO link for communication with the UE 602, based at least on the generated real channel matrix.

As illustrated at 620, the base station 604 may determine a downlink channel state information (CSI) to compensate for the insertion loss at each MIMO link. The base station 604 may determine the downlink CSI to compensate for the insertion loss at each MIMO link based at least on the offset matrix correction.

As illustrated at 622, the base station 604 and the UE 602 may communicate with each other based at least on the downlink CSI that is configured to compensate for the insertion loss at each MIMO link.

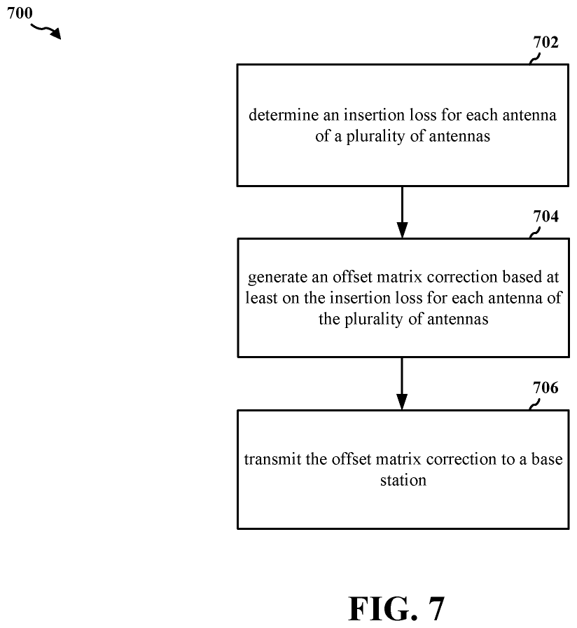

FIG. 7 is a flowchart 700 of a method of wireless communication. The method may be performed by a UE or a component of a UE (e.g., the UE 104, 402, 502, 602; the apparatus 902; the cellular baseband processor 904, which may include the memory 360 and which may be the entire UE 350 or a component of the UE 350, such as the TX processor 368, the RX processor 356, and/or the controller/processor 359). One or more of the illustrated operations may be omitted, transposed, or contemporaneous. The method may allow a UE to generate a static offset related to an imbalance on transmission power for each antenna.

At 702, the UE may determine an insertion loss. For example, 702 may be performed by determination component 940 of apparatus 902. The UE may determine the insertion loss for each antenna of a plurality of antennas. In some aspects, the insertion loss for each antenna of the plurality of antennas may be based at least on an antenna switching configuration.

At 704, the UE may generate an offset matrix correction. For example, 704 may be performed by generate component 942 of apparatus 902. The UE may generate the offset matrix correction based at least on the insertion loss for each antenna of the plurality of antennas. In some aspects, the offset matrix correction may comprise a report of an insertion loss delta for each antenna of the plurality of antennas with respect to a first antenna of the plurality of antennas. The offset matrix correction may comprise offset coefficients corresponding to the insertion loss delta for each antenna of the plurality of antennas. In some aspects, the offset matrix correction may comprise a report of the insertion loss for each antenna of the plurality of antennas. In some aspects, the offset matrix correction may comprise an index for a sequence of active antennas of the plurality of antennas. The sequence of active antennas may be associated with a respective insertion loss. The offset matrix correction is transmitted via medium access control control element (MAC-CE). In some aspects, the offset matrix correction may be based on a per band or a per band in a band combination.

At 706, the UE may transmit the offset matrix correction. For example, 706 may be performed by offset component 944 of apparatus 902. The UE may transmit the offset matrix correction to a base station.

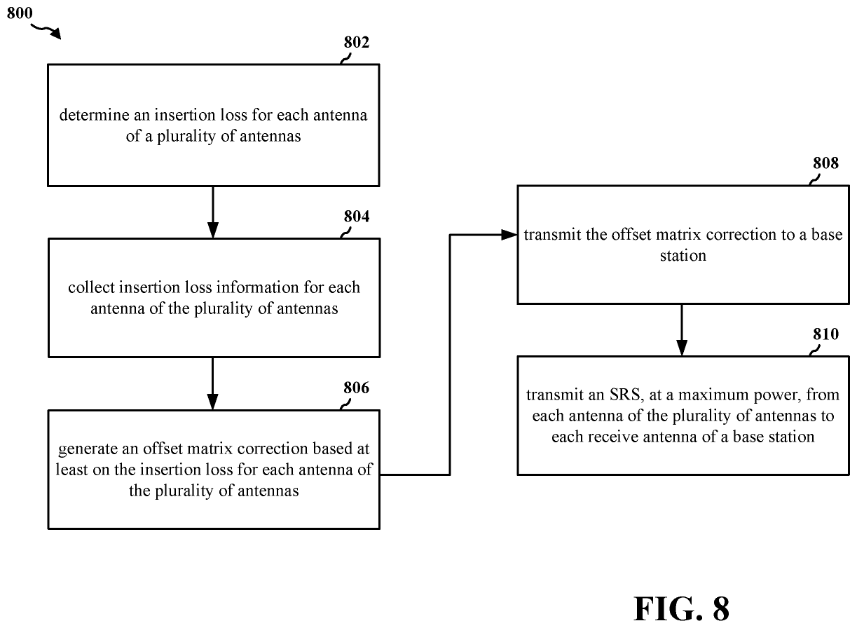

FIG. 8 is a flowchart 800 of a method of wireless communication. The method may be performed by a UE or a component of a UE (e.g., the UE 104, 402, 502, 602; the apparatus 902; the cellular baseband processor 904, which may include the memory 360 and which may be the entire UE 350 or a component of the UE 350, such as the TX processor 368, the RX processor 356, and/or the controller/processor 359). One or more of the illustrated operations may be omitted, transposed, or contemporaneous. The method may allow a UE to generate a static offset related to an imbalance on transmission power for each antenna.

At 802, the UE may determine an insertion loss. For example, 802 may be performed by determination component 940 of apparatus 902. The UE may determine the insertion loss for each antenna of a plurality of antennas. In some aspects, the insertion loss for each antenna of the plurality of antennas may be based at least on an antenna switching configuration.

At 804, the UE may collect insertion loss information. For example, 804 may be performed by collect component 948 of apparatus 902. The UE may collect the insertion loss information for each antenna of the plurality of antennas. The insertion loss information may indicate at least a power difference for each of the plurality of antennas at the UE.

At 806, the UE may generate an offset matrix correction. For example, 806 may be performed by generate component 942 of apparatus 902. The UE may generate the offset matrix correction based at least on the insertion loss for each antenna of the plurality of antennas. In some aspects, the offset matrix correction may comprise a report of an insertion loss delta for each antenna of the plurality of antennas with respect to a first antenna of the plurality of antennas. The offset matrix correction may comprise offset coefficients corresponding to the insertion loss delta for each antenna of the plurality of antennas. In some aspects, the offset matrix correction may comprise a report of the insertion loss for each antenna of the plurality of antennas. In some aspects, the offset matrix correction may comprise an index for a sequence of active antennas of the plurality of antennas. The sequence of active antennas may be associated with a respective insertion loss. The offset matrix correction is transmitted via medium access control control element (MAC-CE). In some aspects, the offset matrix correction may be based on a per band or a per band in a band combination.

At 808, the UE may transmit the offset matrix correction. For example, 808 may be performed by offset component 944 of apparatus 902. The UE may transmit the offset matrix correction to a base station.

At 810, the UE may transmit a sounding reference signal (SRS) to each receive antenna of the base station. For example, 810 may be performed by SRS component 946 of apparatus 902. The UE may transmit the SRS from each antenna of the plurality of antennas to each receive antenna of the base station. The UE may transmit the SRS, at a maximum power, from each antenna of the plurality of antennas to each receive antenna of the base station.

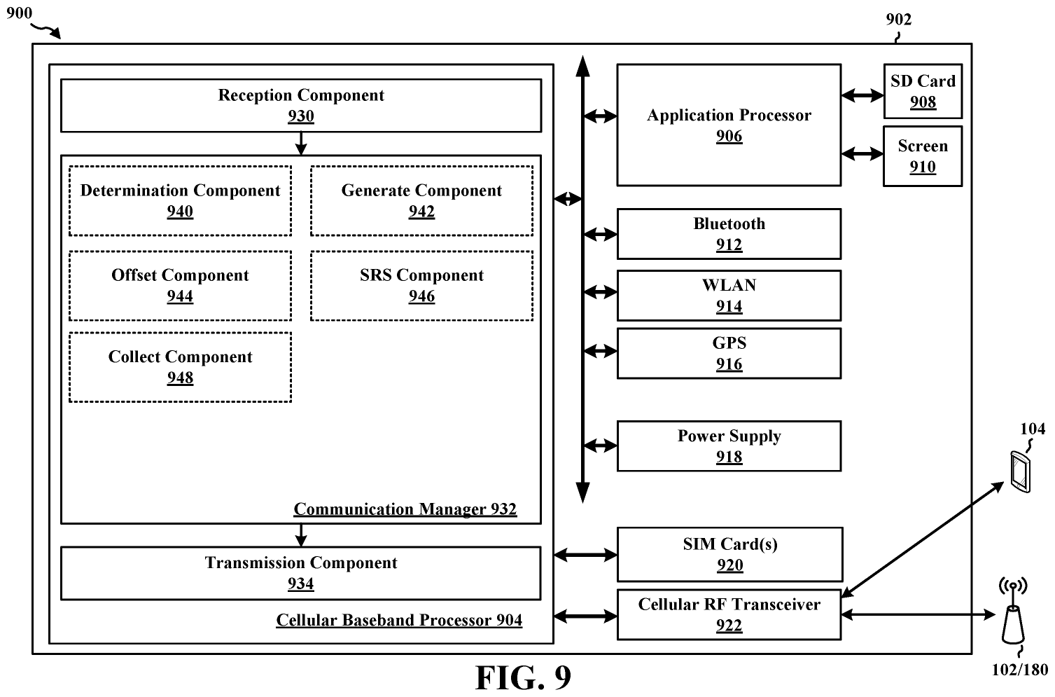

FIG. 9 is a diagram 900 illustrating an example of a hardware implementation for an apparatus 902. The apparatus 902 may be a UE, a component of a UE, or may implement UE functionality. In some aspects, the apparatus 902 may include a cellular baseband processor 904 (also referred to as a modem) coupled to a cellular RF transceiver 922. In some aspects, the apparatus 902 may further include one or more subscriber identity modules (SIM) cards 920, an application processor 906 coupled to a secure digital (SD) card 908 and a screen 910, a Bluetooth module 912, a wireless local area network (WLAN) module 914, a Global Positioning System (GPS) module 916, or a power supply 918. The cellular baseband processor 904 communicates through the cellular RF transceiver 922 with the UE 104 and/or BS 102/180. The cellular baseband processor 904 may include a computer-readable medium/memory. The computer-readable medium/memory may be non-transitory. The cellular baseband processor 904 is responsible for general processing, including the execution of software stored on the computer-readable medium/memory. The software, when executed by the cellular baseband processor 904, causes the cellular baseband processor 904 to perform the various functions described supra. The computer-readable medium/memory may also be used for storing data that is manipulated by the cellular baseband processor 904 when executing software. The cellular baseband processor 904 further includes a reception component 930, a communication manager 932, and a transmission component 934. The communication manager 932 includes the one or more illustrated components. The components within the communication manager 932 may be stored in the computer-readable medium/memory and/or configured as hardware within the cellular baseband processor 904. The cellular baseband processor 904 may be a component of the UE 350 and may include the memory 360 and/or at least one of the TX processor 368, the RX processor 356, and the controller/processor 359. In one configuration, the apparatus 902 may be a modem chip and include just the cellular baseband processor 904, and in another configuration, the apparatus 902 may be the entire UE (e.g., see 350 of FIG. 3) and include the additional modules of the apparatus 902.

The communication manager 932 includes a determination component 940 that is configured to determine an insertion loss, e.g., as described in connection with 702 of FIG. 7 or 802 of FIG. 8. The communication manager 932 further includes a generate component 942 that is configured to generate an offset matrix correction, e.g., as described in connection with 704 of FIG. 7 or 806 of FIG. 8. The communication manager 932 further includes an offset component 944 that is configured to transmit the offset matrix correction, e.g., as described in connection with 706 of FIG. 7 or 808 of FIG. 8. The communication manager 932 further includes an SRS component 946 that is configured to transmit SRS to each receive antenna of the base station, e.g., as described in connection with 810 of FIG. 8. The communication manager 932 further includes a collect component 948 configured to collect insertion loss information, e.g., as described in connection with 804 of FIG. 8.

The apparatus may include additional components that perform each of the blocks of the algorithm in the flowcharts of FIGS. 7 and 8. As such, each block in the flowcharts of FIGS. 7 and 8 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 902 may include a variety of components configured for various functions. In one configuration, the apparatus 902, and in particular the cellular baseband processor 904, includes means for determining an insertion loss for each antenna of a plurality of antennas. The apparatus includes means for generating an offset matrix correction based at least on the insertion loss for each antenna of the plurality of antennas. The apparatus includes means for transmitting the offset matrix correction to a base station. The apparatus further includes means for transmitting an SRS, at a maximum power, from each antenna of the plurality of antennas to each receive antenna of a base station. The apparatus further includes means for collecting insertion loss information for each antenna of the plurality of antennas. The insertion loss information indicates at least a power difference for each of the plurality of antennas at the UE. The means may be one or more of the components of the apparatus 902 configured to perform the functions recited by the means. As described supra, the apparatus 902 may include the TX Processor 368, the RX Processor 356, and the controller/processor 359. As such, in one configuration, the means may be the TX Processor 368, the RX Processor 356, and the controller/processor 359 configured to perform the functions recited by the means.

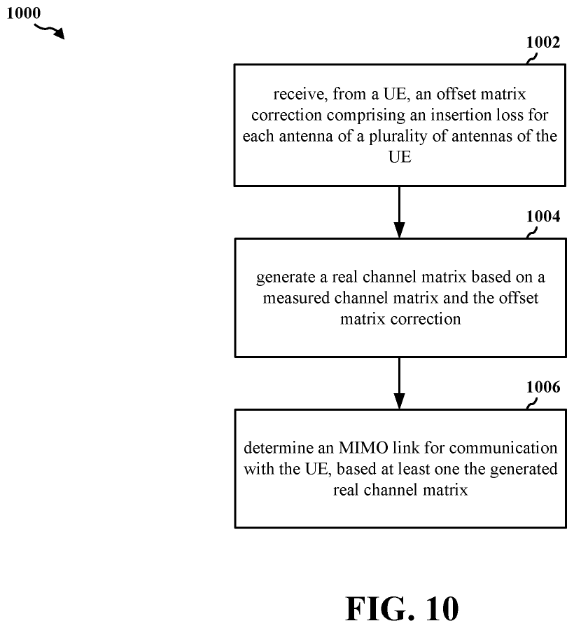

FIG. 10 is a flowchart 1000 of a method of wireless communication. The method may be performed by a base station or a component of a base station (e.g., the base station 102/180, 404, 504, 604; the apparatus 1202; the baseband unit 1204, which may include the memory 376 and which may be the entire base station 310 or a component of the base station 310, such as the TX processor 316, the RX processor 370, and/or the controller/processor 375). One or more of the illustrated operations may be omitted, transposed, or contemporaneous. The method may allow a base station to determine a channel estimate of MIMO links based on insertion loss at the UE.

At 1002, the base station may receive an offset matrix correction. For example, 1002 may be performed by offset component 1240 of apparatus 1202. The base station may receive the offset matrix correction from a UE. The offset matrix correction may comprise an insertion loss for each antenna of a plurality of antennas of the UE. In some aspects, the offset matrix correction may comprise a report of an insertion loss delta for each antenna of the plurality of antennas with respect to a first antenna of the plurality of antennas of the UE. The offset matrix correction may comprise offset coefficients corresponding to the insertion loss delta for each antenna of the plurality of antennas of the UE. In some aspects, the offset matrix correction may comprise a report of insertion loss for each antenna of the plurality of antennas of the UE. In some aspects, the insertion loss for each antenna of the plurality of antennas of the UE may be based at least on an antenna switching configuration. In some aspects, the offset matrix correction may comprise an index for a sequence of active antennas of the plurality of antennas of the UE. The sequence of active antennas is associated with a respective insertion loss. In some aspects, the offset matrix correction may be transmitted via MAC-CE.

At 1004, the base station may generate a real channel matrix. For example, 1004 may be performed by generate component 1244 of apparatus 1202. The base station may generate the real channel matrix based on a measured channel matrix and the offset matrix correction.

At 1006, the base station may determine a MIMO link for communication with the UE. For example, 1006 may be performed by determination component 1246 of apparatus 1202. The base station may determine the MIMO link for communication with the UE, based at least on the generated real channel matrix.

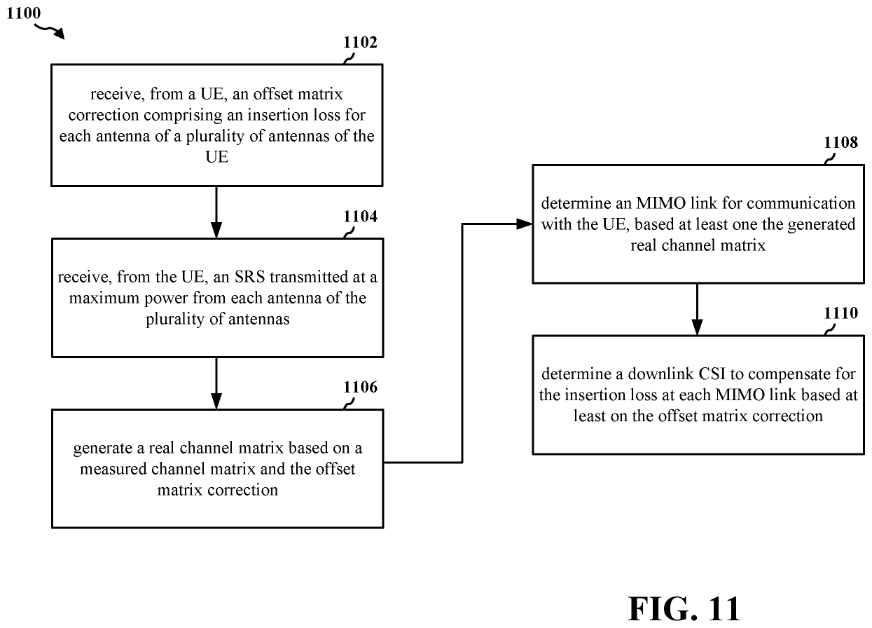

FIG. 11 is a flowchart 1100 of a method of wireless communication. The method may be performed by a base station or a component of a base station (e.g., the base station 102/180, 404, 504, 604; the apparatus 1202; the baseband unit 1204, which may include the memory 376 and which may be the entire base station 310 or a component of the base station 310, such as the TX processor 316, the RX processor 370, and/or the controller/processor 375). One or more of the illustrated operations may be omitted, transposed, or contemporaneous. The method may allow a base station to determine a channel estimate of MIMO links based on insertion loss at the UE.

At 1102, the base station may receive an offset matrix correction. For example, 1102 may be performed by offset component 1240 of apparatus 1202. The base station may receive the offset matrix correction from a UE. The offset matrix correction may comprise an insertion loss for each antenna of a plurality of antennas of the UE. In some aspects, the offset matrix correction may comprise a report of an insertion loss delta for each antenna of the plurality of antennas with respect to a first antenna of the plurality of antennas of the UE. The offset matrix correction may comprise offset coefficients corresponding to the insertion loss delta for each antenna of the plurality of antennas of the UE. In some aspects, the offset matrix correction may comprise a report of insertion loss for each antenna of the plurality of antennas of the UE. In some aspects, the insertion loss for each antenna of the plurality of antennas of the UE may be based at least on an antenna switching configuration. In some aspects, the offset matrix correction may comprise an index for a sequence of active antennas of the plurality of antennas of the UE. The sequence of active antennas is associated with a respective insertion loss. In some aspects, the offset matrix correction may be transmitted via MAC-CE.

At 1104, the base station may receive an SRS. For example, 1104 may be performed by SRS component 1242 of apparatus 1202. The base station may receive the SRS from the UE. The base station may receive the SRS from the UE transmitted at a maximum power from each antenna of the plurality of antennas. The SRS may be received at each receive antenna of the base station.

At 1106, the base station may generate a real channel matrix. For example, 1106 may be performed by generate component 1244 of apparatus 1202. The base station may generate the real channel matrix based on a measured channel matrix and the offset matrix correction.

At 1108, the base station may determine a MIMO link for communication with the UE. For example, 1108 may be performed by determination component 1246 of apparatus 1202. The base station may determine the MIMO link for communication with the UE, based at least on the generated real channel matrix.

At 1110, the base station may determine a downlink CSI to compensate for the insertion loss at each MIMO link. For example, 1110 may be performed by determination component 1246 of apparatus 1202. The base station may determine the downlink CSI to compensate for the insertion loss at each MIMO link based at least on the offset matrix correction.

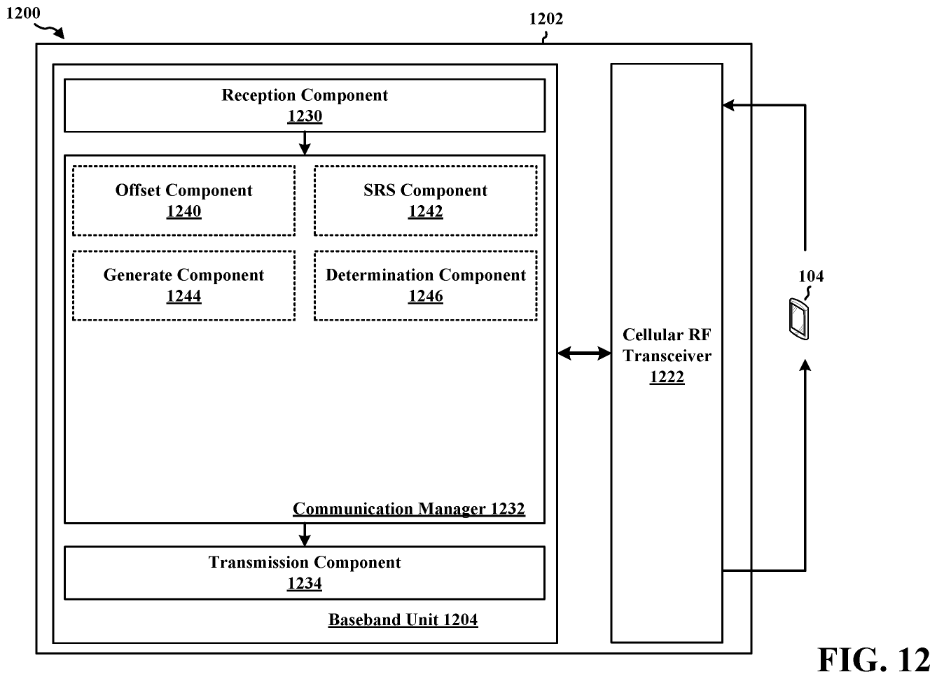

FIG. 12 is a diagram 1200 illustrating an example of a hardware implementation for an apparatus 1202. The apparatus 1202 may be a base station, a component of a base station, or may implement base station functionality. In some aspects, the apparatus 1202 may include a baseband unit 1204. The baseband unit 1204 may communicate through a cellular RF transceiver 1222 with the UE 104. The baseband unit 1204 may include a computer-readable medium/memory. The baseband unit 1204 is responsible for general processing, including the execution of software stored on the computer-readable medium/memory. The software, when executed by the baseband unit 1204, causes the baseband unit 1204 to perform the various functions described supra. The computer-readable medium/memory may also be used for storing data that is manipulated by the baseband unit 1204 when executing software. The baseband unit 1204 further includes a reception component 1230, a communication manager 1232, and a transmission component 1234. The communication manager 1232 includes the one or more illustrated components. The components within the communication manager 1232 may be stored in the computer-readable medium/memory and/or configured as hardware within the baseband unit 1204. The baseband unit 1204 may be a component of the base station 310 and may include the memory 376 and/or at least one of the TX processor 316, the RX processor 370, and the controller/processor 375.

The communication manager 1232 includes an offset component 1240 that may receive an offset matrix correction, e.g., as described in connection with 1002 of FIG. 10 or 1102 of FIG. 11. The communication manager 1232 further includes an SRS component 1242 that may receive an SRS, e.g., as described in connection with 1104 of FIG. 11. The communication manager 1232 further includes a generate component 1244 that may generate a real channel matrix, e.g., as described in connection with 1004 of FIG. 10 or 1106 of FIG. 11. The communication manager 1232 further includes determination component 1046 that may determine a MIMO link for communication with the UE, e.g., as described in connection with 1006 of FIG. 10 or 1108 of FIG. 11. The determination component 1046 may be further configured to determine a downlink CSI to compensate for the insertion loss at each MIMO link, e.g., as described in connection with 1110 of FIG. 11.

The apparatus may include additional components that perform each of the blocks of the algorithm in the flowcharts of FIGS. 10 and 11. As such, each block in the flowcharts of FIGS. 10 and 11 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1202 may include a variety of components configured for various functions. In one configuration, the apparatus 1202, and in particular the baseband unit 1204, includes means for receiving, from a UE, an offset matrix correction comprising an insertion loss for each antenna of a plurality of antennas of the UE. The apparatus includes means for generating a real channel matrix based on a measured channel matrix and the offset matrix correction. The apparatus includes means for determining a MIMO link for communication with the UE, based at least one the generated real channel matrix. The apparatus further includes means for receiving, from the UE, an SRS transmitted at a maximum power from each antenna of the plurality of antennas. The SRS is received at each receive antenna of the base station. The apparatus further includes means for determining a downlink CSI to compensate for the insertion loss at each MIMO link based at least on the offset matrix correction. The means may be one or more of the components of the apparatus 1202 configured to perform the functions recited by the means. As described supra, the apparatus 1202 may include the TX Processor 316, the RX Processor 370, and the controller/processor 375. As such, in one configuration, the means may be the TX Processor 316, the RX Processor 370, and the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.
Aspect 1 is an apparatus for wireless communication at a UE including at least one processor coupled to a memory and configured to determine an insertion loss for each antenna of a plurality of antennas; generate an offset matrix correction based at least on the insertion loss for each antenna of the plurality of antennas; and transmit the offset matrix correction to a base station.
Aspect 2 is the apparatus of aspect 1, further including a transceiver coupled to the at least one processor.
Aspect 3 is the apparatus of any of aspects 1 and 2, further includes that the offset matrix correction comprises a report of an insertion loss delta for each antenna of the plurality of antennas with respect to a first antenna of the plurality of antennas.
Aspect 4 is the apparatus of any of aspects 1-3, further includes that the offset matrix correction comprises offset coefficients corresponding to the insertion loss delta for each antenna of the plurality of antennas.
Aspect 5 is the apparatus of any of aspects 1-4, further includes that the offset matrix correction comprises a report of the insertion loss for each antenna of the plurality of antennas.
Aspect 6 is the apparatus of any of aspects 1-5, further includes that the insertion loss for each antenna of the plurality of antennas is based at least on an antenna switching configuration.
Aspect 7 is the apparatus of any of aspects 1-6, further includes that the offset matrix correction comprises an index for a sequence of active antennas of the plurality of antennas, wherein the sequence of active antennas is associated with a respective insertion loss.
Aspect 8 is the apparatus of any of aspects 1-7, further includes that the offset matrix correction is transmitted via MAC-CE.
Aspect 9 is the apparatus of any of aspects 1-8, further includes that the at least one processor is further configured to transmit a sounding reference signal (SRS), at a maximum power, from each antenna of the plurality of antennas to each receive antenna of the base station.
Aspect 10 is the apparatus of any of aspects 1-9, further includes that the offset matrix correction is based on a per band or the per band in a band combination.
Aspect 11 is the apparatus of any of aspects 1-10, further includes that the at least one processor is further configured to collect insertion loss information for each antenna of the plurality of antennas, wherein the insertion loss information indicates at least a power difference for each of the plurality of antennas at the UE.
Aspect 12 is a method of wireless communication for implementing any of aspects 1-11.
Aspect 13 is an apparatus for wireless communication including means for implementing any of aspects 1-11.
Aspect 14 is a computer-readable medium storing computer executable code, where the code when executed by a processor causes the processor to implement any of aspects 1-11.
Aspect 15 is an apparatus for wireless communication at a base station including at least one processor coupled to a memory and configured to receive, from a UE, an offset matrix correction comprising an insertion loss for each antenna of a plurality of antennas of the UE; generate a real channel matrix based on a measured channel matrix and the offset matrix correction; and determine a MIMO link for communication with the UE, based at least on a generated real channel matrix.
Aspect 16 is the apparatus of aspect 15, further including a transceiver coupled to the at least one processor.
Aspect 17 is the apparatus of any of aspects 15 and 16, further includes that the offset matrix correction comprises a report of an insertion loss delta for each antenna of the plurality of antennas with respect to a first antenna of the plurality of antennas of the UE.
Aspect 18 is the apparatus of any of aspects 15-17, further includes that the offset matrix correction comprises offset coefficients corresponding to the insertion loss delta for each antenna of the plurality of antennas of the UE.
Aspect 19 is the apparatus of any of aspects 15-18, further includes that the offset matrix correction comprises a report of the insertion loss for each antenna of the plurality of antennas of the UE.
Aspect 20 is the apparatus of any of aspects 15-19, further includes that the insertion loss for each antenna of the plurality of antennas of the UE is based at least on an antenna switching configuration.
Aspect 21 is the apparatus of any of aspects 15-20, further includes that the offset matrix correction comprises an index for a sequence of active antennas of the plurality of antennas of the UE, wherein the sequence of active antennas is associated with a respective insertion loss.
Aspect 22 is the apparatus of any of aspects 15-21, further includes that the offset matrix correction is transmitted via MAC-CE.
Aspect 23 is the apparatus of any of aspects 15-22, further includes that the at least one processor is further configured to receive, from the UE, a sounding reference signal (SRS) transmitted at a maximum power from each antenna of the plurality of antennas, wherein the SRS is received at each receive antenna of the base station.
Aspect 24 is the apparatus of any of aspects 15-23, further includes that the at least one processor is further configured to determine a downlink CSI to compensate for the insertion loss at each MIMO link based at least on the offset matrix correction.
Aspect 25 is a method of wireless communication for implementing any of aspects 15-24.
Aspect 26 is an apparatus for wireless communication including means for implementing any of aspects 15-24.
Aspect 27 is a computer-readable medium storing computer executable code, where the code when executed by a processor causes the processor to implement any of aspects 15-24.

1. An apparatus for wireless communication at a user equipment (UE), comprising:
a memory; and
at least one processor, coupled to the memory, and configured to:
determine an insertion loss for each antenna of a plurality of antennas;
generate an offset matrix correction based at least on the insertion loss for each antenna of the plurality of antennas; and
transmit the offset matrix correction to a base station.

2. The apparatus of claim 1, further comprising a transceiver coupled to the at least one processor.

3. The apparatus of claim 1, wherein the offset matrix correction comprises a report of an insertion loss delta for each antenna of the plurality of antennas with respect to a first antenna of the plurality of antennas.

4. The apparatus of claim 3, wherein the offset matrix correction comprises offset coefficients corresponding to the insertion loss delta for each antenna of the plurality of antennas.

5. The apparatus of claim 1, wherein the offset matrix correction comprises a report of the insertion loss for each antenna of the plurality of antennas.

6. The apparatus of claim 1, wherein the insertion loss for each antenna of the plurality of antennas is based at least on an antenna switching configuration.

7. The apparatus of claim 1, wherein the offset matrix correction comprises an index for a sequence of active antennas of the plurality of antennas, wherein the sequence of active antennas is associated with a respective insertion loss.

8. The apparatus of claim 7, wherein the offset matrix correction is transmitted via medium access control (MAC) control element (CE) (MAC-CE).

9. The apparatus of claim 1, wherein the at least one processor is further configured to:
transmit a sounding reference signal (SRS), at a maximum power, from each antenna of the plurality of antennas to each receive antenna of the base station.

10. The apparatus of claim 1, wherein the offset matrix correction is based on a per band or the per band in a band combination.

11. The apparatus of claim 1, wherein the at least one processor is further configured to:
collect insertion loss information for each antenna of the plurality of antennas, wherein the insertion loss information indicates at least a power difference for each of the plurality of antennas at the UE.

12. A method of wireless communication at a user equipment (UE), comprising:
determining an insertion loss for each antenna of a plurality of antennas;
generating an offset matrix correction based at least on the insertion loss for each antenna of the plurality of antennas; and
transmitting the offset matrix correction to a base station.

13. The method of claim 12, wherein the offset matrix correction comprises a report of an insertion loss delta for each antenna of the plurality of antennas with respect to a first antenna of the plurality of antennas.

14. The method of claim 13, wherein the offset matrix correction comprises offset coefficients corresponding to the insertion loss delta for each antenna of the plurality of antennas.

15. The method of claim 12, further comprising:
transmitting a sounding reference signal (SRS), at a maximum power, from each antenna of the plurality of antennas to each receive antenna of the base station.

16. The method of claim 12, further comprising:
collecting insertion loss information for each antenna of the plurality of antennas, wherein the insertion loss information indicates at least a power difference for each of the plurality of antennas at the UE.

17. An apparatus for wireless communication at a base station, comprising:
a memory; and
at least one processor, coupled to the memory, and configured to:
receive, from a user equipment (UE), an offset matrix correction comprising an insertion loss for each antenna of a plurality of antennas of the UE;
generate a real channel matrix based on a measured channel matrix and the offset matrix correction; and
determine a multiple input multiple output (MIMO) link for communication with the UE, based at least on a generated real channel matrix.

18. The apparatus of claim 17, further comprising a transceiver coupled to the at least one processor.

19. The apparatus of claim 17, wherein the offset matrix correction comprises a report of an insertion loss delta for each antenna of the plurality of antennas with respect to a first antenna of the plurality of antennas of the UE.

20. The apparatus of claim 19, wherein the offset matrix correction comprises offset coefficients corresponding to the insertion loss delta for each antenna of the plurality of antennas of the UE.

21. The apparatus of claim 17, wherein the offset matrix correction comprises a report of the insertion loss for each antenna of the plurality of antennas of the UE.

22. The apparatus of claim 17, wherein the insertion loss for each antenna of the plurality of antennas of the UE is based at least on an antenna switching configuration.

23. The apparatus of claim 17, wherein the offset matrix correction comprises an index for a sequence of active antennas of the plurality of antennas of the UE, wherein the sequence of active antennas is associated with a respective insertion loss.

24. The apparatus of claim 23, wherein the offset matrix correction is transmitted via medium access control control element (MAC-CE).

25. The apparatus of claim 17, wherein the at least one processor is further configured to:
receive, from the UE, a sounding reference signal (SRS) transmitted at a maximum power from each antenna of the plurality of antennas, wherein the SRS is received at each receive antenna of the base station.

26. The apparatus of claim 17, wherein the at least one processor is further configured to:
determine a downlink channel state information (CSI) to compensate for the insertion loss at each MIMO link based at least on the offset matrix correction.

27. A method of wireless communication at a base station, comprising:
receiving, from a user equipment (UE), an offset matrix correction comprising an insertion loss for each antenna of a plurality of antennas of the UE;
generating a real channel matrix based on a measured channel matrix and the offset matrix correction; and
determining a multiple input multiple output (MIMO) link for communication with the UE, based at least on a generated real channel matrix.

28. The method of claim 27, wherein the offset matrix correction comprises a report of an insertion loss delta for each antenna of the plurality of antennas with respect to a first antenna of the plurality of antennas of the UE.

29. The method of claim 27, further comprising:
receiving, from the UE, a sounding reference signal (SRS) transmitted at a maximum power from each antenna of the plurality of antennas, wherein the SRS is received at each receive antenna of the base station.

30. The method of claim 27, further comprising:
determining a downlink channel state information (CSI) to compensate for the insertion loss at each MIMO link based at least on the offset matrix correction.
